(19) United States
(12) Patent Application Publication
(10) Pub. No.: US 2024/0037481 A1
(43) Pub. Date: Feb. 1, 2024

(54) WEATHER FACTOR

(71) Applicant: DTN Europe B.V., Utrecht (NL)

(72) Inventor: Jacob Oscar VAN DEN BRINK, WINTERSWIJK (NL)

(21) Appl. No.: 18/227,711

(22) Filed: Jul. 28, 2023

Related U.S. Application Data
(60) Provisional application No. 63/393,370, filed on Jul. 29, 2022.

(51) Int. Cl. G06Q 10/067; G06Q 10/0631; G06Q 10/0831

(52) U.S. Cl. CPC G06Q 10/067; G06Q 10/06315; G06Q 10/0831

(57) ABSTRACT

A system for and method of determining anticipated voyage costs are provided. The system and method utilize a plurality of voyage simulations to determine cost information for each simulation. The voyage simulations utilize a digital twin model of a vessel, anticipated routes for the vessel, and weather data associated with each route. The results of the simulations are used to generate statistical probability for anticipated costs for a voyage, thereby facilitating more accurate predictions of costs that can be used to assess voyage feasibility and profitability.

### CROSS-REFERENCE TO RELATED APPLICATIONS

This application claims priority pursuant to 35 U.S.C. 119(e) to U.S. Provisional Patent Application Ser. No. 63/393,370, filed Jul. 29, 2022, the entire disclosure of which is incorporated herein by reference.

### FIELD OF THE INVENTION

The present invention relates generally to transportation. More specifically, the present invention is concerned with shipping optimizations.

### BACKGROUND

Shipping costs are variable and weather can have a significant adverse impact on profit margins for shipping. To transport a given freight at sea—on average—two-thirds of the voyage costs are attributed to fuel consumption. This makes accurate fuel consumption predictions highly valuable, especially for traders who must price cargo several weeks ahead of such cargo being transported. Accordingly, it would be beneficial to have a system for and a method of predicting fuel consumption.

Voyage profit is determined by subtracting voyage costs from voyage revenue. In general, voyage cost is determined by the fuel consumption, the fuel price, the fuel emission price, the voyage duration, the ship charter rates, and port charges, most of which is highly variable. Voyage revenue, on the other hand, is determined by multiplying cargo weight by freight rate, which tend to be known values, and possibly negotiated values. Accordingly, it would be beneficial to have a system for and a method of determining reliable anticipated voyage costs so that reliable anticipated profits can be determined (or negotiated) for a variety of potential freight rates, thereby assisting traders to make better margins and/or assisting traders to avoid non-profitable deals.

Fuel consumption and voyage duration predictions are a complex task, and many factors must be taken into consideration, such as certain factors that are sometimes referred to as sea margin or weather margin (herein “Weather Factor”).

Weather Factor is the increase in voyage fuel consumption and voyage duration due to significant weather enroute compared to the voyage performed under non-significant weather conditions. Because there are so many factors associated with weather, it is unwise to rely solely on experience and ‘gut’ feel before embarking on a voyage. Accordingly, it would be advantageous to have a system for and a method of accurately determining anticipated Weather Factors for a voyage.

There are several existing solutions for determining Weather Factor, but each solution has its limitations and disadvantages. For instance, some existing solutions utilize fixed Weather Factors, some of which account for seasonal changes. Unfortunately, determining Weather Factors by selecting from pre-determined fixed Weather Factor values provides limited accuracy and is subject to human bias. Accordingly, it would be beneficial to have a system for and method of determining Weather Factor with a high level of accuracy. Furthermore, it would be beneficial to have a system and method that eliminates or otherwise limits the influence of human bias when determining Weather Factors.

Other existing solutions utilize historical shipping data or statistical post-processing. Unfortunately, such approaches often suffer from a lack of statistical significance due to a low population size of datapoints. There are just too few historical routes with the same type of vessel, similar speed, and similar departure destination points. There are even fewer relevant historical routes when considering that the time of year can be a major factor for determining accurate statistical predictions. In other words, reliability of anticipated future Weather Factors is limited when Weather Factors are determined using limited historical and/or statistical information. Accordingly, it would be beneficial to have a system for and a method of determining reliable Weather Factors.

Other existing solutions utilize one-off case studies. Unfortunately, such studies are time consuming. Furthermore, such studies tend to be narrowly tailored towards one vessel (class) and/or towards specific routes. Any changes require a brand new, time-consuming, case study. Accordingly, it would be beneficial to have a system for and method of quickly determining a Weather Factor. It would be even more beneficial to quickly determine a variety of Weather Factors based on a variety of Weather Factor influencers (herein “Influencers”), thereby increasing the applicability of the information.

### SUMMARY

The present invention comprises a system for and a method of obtaining accurate predictions of fuel consumption for long voyages, thereby assisting traders price cargo several weeks ahead of such cargo being transported. In some embodiments, the system utilizes a variety of information to determine anticipated fuel consumption, such as ship characteristics, cargo weight, anticipated departure date, anticipated weather, anticipated route, anticipated speed, anticipated duration of the voyage, and the like.

The present invention further comprises a system for and a method of determining reliable anticipated voyage costs, thereby assisting traders to make better margins and/or assisting traders to avoid non-profitable deals.

Furthermore still, the present invention comprises a system for and a method of accurately determining anticipated Weather Factors.

Furthermore, the present invention determines accurate Weather Factor.

Furthermore, the present invention eliminates or otherwise limits the influence of human bias when determining Weather Factor.

Furthermore, the present invention determines reliable Weather Factors.

Furthermore, the present invention quickly determines a variety of Weather Factors based on a variety of Influencers.

In some embodiments, the present invention utilizes a simulation model during a simulation step. In some such embodiments, the simulation model is a high-fidelity digital twin model of the vessel, thereby accounting for the vessel specific characteristics. In some embodiments, the simulation step utilizes a routing algorithm, such as a search algorithm. In some embodiments, the algorithm makes use of weather data (weather optimized routing) and optimizes a route on overall shortest time, lowest fuel consumption, lowest total costs, or the like. In some embodiments, the simulation model is used to determine the impact of external influences on the vessel (like adverse weather or currents) during the simulation, which influence the overall vessel performance, such as through loss of speed, increased fuel consumption, and increased emissions. In some embodiments, the present invention facilitates the development of one or more anticipated routes and/or identifying one or more restricted routes and/or areas.

In some embodiments, the present invention utilizes historical information, such as historical weather/climate information. In some embodiments, the present invention utilizes current information, such as weather observation data. In some embodiments, the present invention utilizes forecast information, such as weather forecast information. In some embodiments, the present invention utilizes a variety of information, such as historical, current, and/or forecast information.

### BRIEF DESCRIPTION OF THE DRAWINGS

Embodiments of the present invention are described in detail below with reference to the attached drawing figures, wherein:

FIG. 1 is a chart displaying the distribution of variable cost associated with enroute weather conditions according to some embodiments of the present invention.

FIG. 2 is a diagram depicting a process overview and voyage simulation according to some embodiments of the present invention.

FIG. 3 is a visual representation of three digital twins associated with the present invention, each of the digital twins being associated with a different period of time.

FIG. 4A is a visual representation of the three digital twins of FIG. 3, each digital twin being shown in a relative position towards the beginning of a voyage.

FIG. 4B is a visual representation of the three digital twins of FIG. 3, each digital twin being shown in a relative position towards the middle of a voyage.

FIG. 4C is a visual representation of the three digital twins of FIG. 3, each digital twin being shown in a relative position towards the end of a voyage.

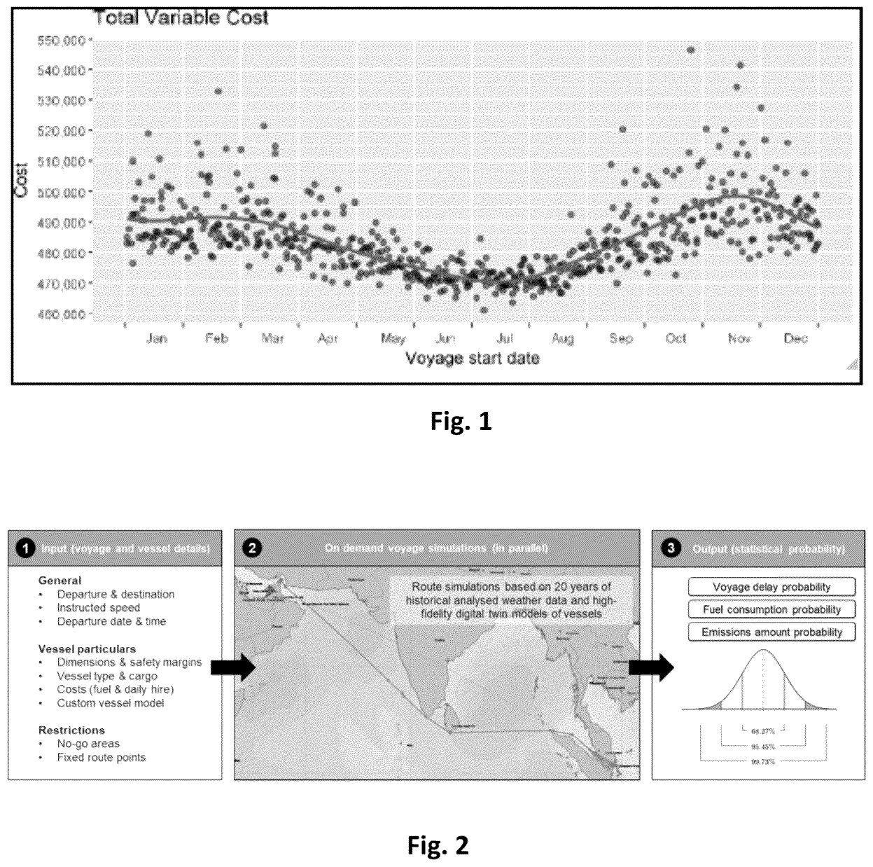

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention comprises a dynamic Weather Factor system and method. In some embodiments, the system utilizes a dual-stage Weather Factor determination process. In some embodiments, the first stage of the process is a simulation stage. In some embodiments, the second stage of the process is a dynamic statistical output stage. In some embodiments, the dual-stage Weather Factor determination system and method utilize a plurality of inputs, such as pieces of data, to initiate either the first or second stage, or both.

In some embodiments, the inputs include one or more of voyage and/or vessel details. In some embodiments, general voyage details include one or more of departure and destination locations (and/or coordinates), the instructed and/or anticipated speed of the voyage, the departure date and time, and the like. In some embodiments, the vessel details (or particulars) include one or more of the dimensions of the vessel (specific and/or approximate), the safety margins of the vessel (such as the under keel clearance, or UKC), the draft of the vessel, the depth of the vessel, and the like. The vessel details, in some embodiments, further includes one or more details related to vessel type and cargo, such as cargo type, cargo capacity, and the like. In some embodiments, the inputs further include one or more of costs, such as fuel costs, personnel costs, maintenance costs, and the like. In some embodiments, the input further includes one or more details of a model of the vessel, such as a digital model which includes one or more characteristics representative of the vessel undertaking the voyage. In some embodiments, the inputs include one or more restrictions. In some embodiments, the restrictions are no-go areas, such as areas restricted by environmental regulations, areas restricted by legal regulations, and the like. In some embodiments, the system adheres to and/or provides indications of a variety of restrictions and considerations, such as traffic separation schemes, default harbor approaches, dangerous cargo type restrictions, vessel dimension restrictions, vertical clearance restrictions at bridges, maximum draft restrictions, depth restrictions, vessel gross tonnage restrictions, vessel class restrictions, shortcut areas based on the departure or destination harbor, seasonal whale protection areas with speed limits, vertex restrictions to stay away from northern or southern hemisphere ice areas, piracy avoidance areas, user specific avoidance areas, and the like. In some embodiments, one or more details of the route are included in the inputs. In some embodiments, the details of the route include one or more fixed point, or waypoints, which are suggested and/or required points that the route ideally or must pass through during the voyage.

In some embodiments, a high-fidelity digital twin model of the vessel is included. The digital twin model includes the specific characteristics of its real-world counterpart. The digital twin model may include, for example, the vessel's dimensions, performance characteristics, maintenance requirements, and data-driven models of the vessel's physical components and characteristics.

In some embodiments, the input includes historical weather data. In some embodiments, the historical weather data includes data such as historical wind conditions, ocean conditions, precipitation, temperatures, and other weather conditions which are relevant to the assessment of the voyage. In some embodiments, the historical weather data is based on a pre-determined time frame of historical weather conditions, such as the previous 20 years.

In some embodiments, the first stage of the system and method includes a simulation. In some embodiments, the simulation is a voyage simulation. In some embodiments, the voyage simulation utilizes one or more of the inputs (such as the digital twin) and the historical weather data. The simulation, in some embodiments, is performed by a computer system, which may be programmed to simulate the voyage. The computer system, in some embodiments, is programmed to simulate the voyage by running one or more programs and/or modules. In some embodiments, the computer system is programmed to simulate the voyage by running a plurality of individual simulations, each simulation being based on a different set of historical weather conditions. In some embodiments, the computer system is programmed to simulate the vessel's progress along the route by considering the inputs and the historical weather conditions. In some embodiments, the computer system is programmed to simulate the vessel's progress along the route by considering the inputs and the historical weather conditions and by making predictions about the future weather conditions. In some embodiments, the computer system is programmed to simulate the vessel's progress along the route by considering the inputs and the historical weather conditions and by making predictions about the future weather conditions and by making predictions about the vessel's performance in relation to the future weather conditions. In some embodiments, the computer system is programmed to simulate the vessel's progress along the route by considering the inputs and the historical weather conditions and by making predictions about the future weather conditions and by making predictions about the vessel's performance in relation to the future weather conditions and by making predictions about the vessel's costs in relation to the future weather conditions.

In some embodiments, during the first stage the computer system is programmed to determine the vessel's progress based, at least partly (but in some embodiments entirely) on a set of pre-determined rules or data points. In some embodiments, the pre-determined rules include one or more non-dynamic aspects of the voyage, the inputs, and/or the weather data. For example, if the vessel is scheduled to arrive at a port at a certain time, the computer system will simulate the vessel's progress to that point in time, while if the vessel is scheduled to depart from a port at a certain time, the computer system will simulate the vessel's progress from that point in time. By way of further example, if the vessel is scheduled to make a stop at a certain location, the computer system will simulate the vessel's progress to that point, and if the vessel is scheduled to make a stop at a certain location for a certain amount of time, the computer system will simulate the vessel's progress to that point and will simulate the vessel's progress for the duration of the stop, and further if the vessel is scheduled to make a stop at a certain location for a certain amount of time and is then scheduled to depart at a certain time, the computer system will simulate the vessel's progress to that point, will simulate the vessel's progress for the duration of the stop, and will simulate the vessel's progress from that point.

In some embodiments, the computer simulates a multitude of simulated voyages in parallel. In some embodiments, one or more algorithm is utilized in performing one or more simulations. In some embodiments, the various simulations utilize the same input parameters, while in some embodiments each simulation utilizes input parameters with variances, while in some embodiments some input parameters are similar across simulations while one or more other input parameters differ across simulations. In some embodiments, the historical weather data is one input parameters which is, in some embodiments, similar across simulations, and in some embodiments different across simulations. In some embodiments, the historical weather data is segmented by time (such as by minute, hour, day, month, year, and the like), and in some embodiments the various simulations utilize different time segments of the historical weather data as at least one input of each of the various simulations.

In some embodiments, the second stage of the system and method includes one or more dynamic statistical outputs. In some embodiments, the dynamic statistical output is a statistical probability. In some embodiments, the statistical probabilities are a result of one or more outputs of the multitude of simulations performed in the first stage of the system and method. In some embodiments, the statistical probabilities and/or outputs indicate the likelihood of occurrence (based, in some embodiments, on one or more simulation) of one or more parameter. In some embodiments, such parameters include, but are not limited to, fuel consumption, emissions amount, and voyage duration.

The probability of the occurrence of the parameter, in some embodiments, is represented as a percentage, or a number of occurrences out of a total number of simulations performed. In some embodiments, the statistical probability is represented as a distribution. In some embodiments, the distribution is a normal distribution. In some embodiments, the distribution is represented as a curve. In some embodiments, the distribution is a histogram. In some embodiments, the statistical probability is represented by percentiles.

In some embodiments, the dynamic statistical output further includes one or more details of the simulations. In some embodiments, the dynamic statistical output further includes one or more details of the voyages simulated in the first stage. In some embodiments, the dynamic statistical output further includes one or more details of the weather conditions utilized in the various simulations. In some embodiments, the dynamic statistical output further includes one or more details of the vessel's performance in the various simulations. In some embodiments, the dynamic statistical output further includes one or more details of the vessel's costs in the various simulations.

In some embodiments, the dynamic statistical output further includes one or more recommendations, such as a recommended route or route correction. In some embodiments, the recommendations are based on the statistical probabilities and/or the details of the simulations. In some embodiments, the recommendations are based on the statistical probabilities and/or the details of the simulations and are generated by a computer system. In some embodiments, the recommendations are based on the statistical probabilities and/or the details of the simulations and are generated by a computer system which is programmed to generate the recommendations, such as through one or more algorithm. In some embodiments, the recommendations are based on the statistical probabilities and/or the details of the simulations and are generated by a computer system which is programmed to generate the recommendations by utilizing one or more programs and/or modules. In some embodiments, the recommendations are based on the statistical probabilities and/or the details of the simulations and are generated by a computer system which is programmed to generate the recommendations by utilizing one or more programs and/or modules and by utilizing one or more algorithms.

In some embodiments, the system and method further include utilizing the disclosed first and second stages to further implement a third stage. In some embodiments, the third stage includes combining one or more output of the second stage with the one or more forecast weather data. In some embodiments, the combination is implemented on a computing system with one or more algorithm. In some embodiments, the result of the combination is one or more output, the output providing an estimated or precise arrival time of one or more enroute vessel.

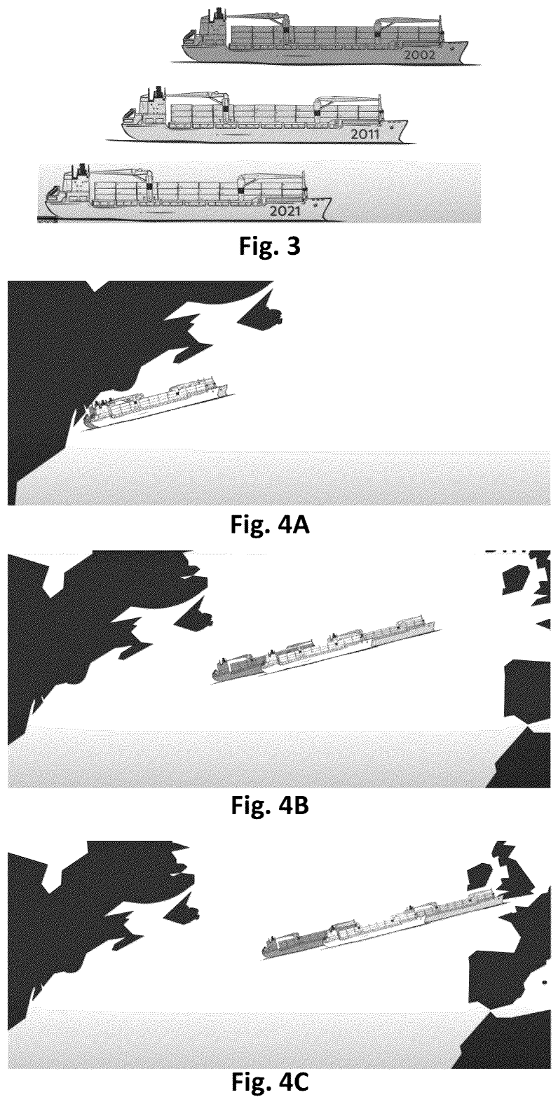

In some embodiments, the present invention includes a system for determining anticipated costs for an anticipated voyage for a vessel, such as a shipping vessel or the like. In some such embodiments, the system and method include or utilize a voyage simulator for running a plurality of voyage simulations. Referring to FIG. 3 and FIGS. 4A-4C, some of the plurality of voyage simulations follow the same, or similar, routes using weather information from respective time periods, thereby facilitating determination of cost information, such as voyage duration, fuel consumption, and emissions, for each time period. In other embodiments, some of the plurality of voyage simulations follow different routes using weather information from the same, or similar, time period. In still other embodiments, some of the plurality of voyage simulations follow different routes using weather information from respective time periods.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof

What is claimed is:

1. A system for determining anticipated costs for an anticipated voyage for a vessel, the system comprising a voyage simulator for running a plurality of voyage simulations, each voyage simulation utilizing voyage information, vessel information, and weather information to determine cost information.

2. The system of claim 1, wherein the voyage simulator utilizes a digital twin model of the vessel, at least some of the vessel information being utilized to define the digital twin model.

3. The system of claim 2, wherein the voyage information comprises at least one of:
departure location;
departure date and time;
an anticipated route;
instructed or anticipated travel speed;
destination location; and
required or desired arrival date and time.

4. The system of claim 3, wherein the cost information comprises at least one of:
fuel consumption;
emissions amount; and
voyage duration.

5. The system of claim 4, wherein the weather information is associated with a geographical area including the anticipated route and a first alternative route.

6. The system of claim 5, wherein the plurality of voyage simulations comprises first and second voyage simulations, wherein the first voyage simulation utilizes voyage information associated with the anticipated route, and wherein the second voyage simulation utilizes voyage information associated with the first alternative route.

7. The system of claim 5, wherein the plurality of voyage simulations comprises first and second voyage simulations, wherein the first voyage simulation utilizes weather information associated with a first period of time, wherein the second voyage simulation utilizes weather information associated with a second period of time, and wherein the first and second periods of time are temporally displaced at least one year from each other.

8. The system of claim 7, wherein the first voyage simulation utilizes voyage information associated with the anticipated route, and wherein the second voyage simulation utilizes voyage information associated with the first alternative route.

9. The system of claim 8, further comprising a probability module that is configured to determine a first statistical probability of anticipated cost for the voyage based on cost information from each of the plurality of voyage simulations.

10. The system of claim 9, wherein the first statistical probability of anticipated cost is associated with a first anticipated cost, and wherein the probability module is further configured to determine a second statistical probability of anticipated cost associated with a second anticipated cost.

11. A method for determining anticipated costs for an anticipated voyage for a vessel, the method comprising:
running a plurality of voyage simulations, wherein each voyage simulation utilizes:
vessel information;
voyage information; and
weather information; and
determining cost information for each voyage simulation.

12. The method of claim 11, wherein the voyage simulator utilizes a digital twin model of the vessel, at least some of the vessel information being utilized to define the digital twin model.

13. The method of claim 12, wherein the voyage information comprises at least one of:
departure location;
departure date and time;
an anticipated route;
instructed or anticipated travel speed;
destination location; and
required or desired arrival date and time.

14. The method of claim 13, wherein the cost information comprises at least one of:
fuel consumption;
emissions amount; and
voyage duration.

15. The method of claim 14, wherein the weather information is associated with a geographical area including the anticipated route and a first alternative route.

16. The method of claim 15, wherein the plurality of voyage simulations comprises first and second voyage simulations, wherein the first voyage simulation utilizes voyage information associated with the anticipated route, and wherein the second voyage simulation utilizes voyage information associated with the first alternative route.

17. The method of claim 15, wherein the plurality of voyage simulations comprises first and second voyage simulations, wherein the first voyage simulation utilizes weather information associated with a first period of time, wherein the second voyage simulation utilizes weather information associated with a second period of time, and wherein the first and second periods of time are temporally displaced at least one year from each other.

18. The method of claim 17, wherein the first voyage simulation utilizes voyage information associated with the anticipated route, and wherein the second voyage simulation utilizes voyage information associated with the first alternative route.

19. The method of claim 18, further comprising determining a first statistical probability of anticipated cost for the voyage based on cost information from each of the plurality of voyage simulations.

20. The method of claim 19, further comprising determining a second statistical probability of anticipated cost, the first and second statistical probabilities of anticipated cost being associated with respective first and second anticipated costs.
